(19) United States
(12) Patent Application Publication
(10) Pub. No.: US 2025/0238191 A1
(43) Pub. Date: Jul. 24, 2025

(54) Calibration of a Playback Device Based on an Estimated Frequency Response

(71) Applicant: Sonos, Inc., Goleta, CA (US)

(72) Inventors: Shao-Fu Shih, Boston, MA (US); Patrick McPherson, Somerville, MA (US)

(21) Appl. No.: 19/027,809

(22) Filed: Jan. 17, 2025

Related U.S. Application Data
(63) Continuation of application No. 18/343,487, filed on Jun. 28, 2023, now Pat. No. 12,260,151.
Application No. 18/343,487 is a continuation of application No. 17/107,157, filed on Nov. 30, 2020, now Pat. No. 11,698,770.
Application No. 17/107,157 is a continuation of application No. 16/665,415, filed on Oct. 28, 2019, now Pat. No. 10,853,027.
Application No. 16/665,415 is a continuation of application No. 15/229,693, filed on Aug. 5, 2016, now Pat. No. 10,459,684.

(51) Int. Cl. G06F 3/16; H04R 3/04; H04R 27/00; H04R 29/00

(52) U.S. Cl. CPC G06F 3/165; H04R 27/00; H04R 29/007; H04R 3/04; H04R 2227/003; H04R 2227/005; H04R 2227/007; H04R 2420/07

(57) ABSTRACT

An example playback device is configured to receive a first stream of audio comprising source audio content to be played back by the playback device and record, via one or more microphones of the playback device, an audio signal output by the playback device based on the playback device playing the source audio content. The playback device is also configured to determine a transfer function between a frequency-domain representation of the first stream of audio and a frequency-domain representation of the recorded audio signal, and then determine an estimated frequency response of the playback device based on a difference between (i) the transfer function and (ii) a self-response of the playback device, where the self-response of the playback device is stored in a memory of the playback device. Based on the estimated frequency response, the playback device is configured to determine an acoustic calibration adjustment and implement the acoustic calibration adjustment.

### CROSS-REFERENCE TO RELATED APPLICATIONS

This application is a continuation of and claims priority to U.S. patent application Ser. No. 18/343,487, filed on Jun. 28, 2023, which is a continuation of and claims priority to U.S. patent application Ser. No. 17/107,157, filed on Nov. 30, 2020, now U.S. Pat. No. 11,698,770, issued on Jul. 11, 2023, which is a continuation of and claims priority to U.S. patent application Ser. No. 16/665,415, filed on Oct. 28, 2019, now U.S. Pat. No. 10,853,027, issued on Dec. 1, 2020, which is a continuation of and claims priority to U.S. patent application Ser. No. 15/229,693, filed on Aug. 5, 2016, now U.S. Pat. No. 10,459,684, issued on Oct. 29, 2019, the contents of each of which are hereby incorporated by reference in their entirety for all purposes.

### FIELD OF THE DISCLOSURE

The disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play audio in any room that has a networked playback device. Additionally, using the control device, for example, different songs can be streamed to each room with a playback device, rooms can be grouped together for synchronous playback, or the same song can be heard in all rooms synchronously.

Given the ever growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows an example playback system configuration in which certain embodiments may be practiced;

FIG. 2 shows a functional block diagram of an example playback device;

FIG. 3 shows a functional block diagram of an example control device;

FIG. 4 shows an example control device interface;

FIG. 5 shows an example network configuration in which certain embodiments may be practiced;

FIG. 6 shows a functional block diagram of an example network microphone device;

FIG. 7 shows an example environment in which certain embodiments may be practiced;

FIG. 8 shows an example flow diagram of functions associated with calibrating an example playback device;

FIG. 9 shows an example of frequency binning;

FIG. 10 shows an example audio pipeline of an example playback device; and

FIG. 11 shows an example graphical user interface associated with calibration of an example playback device.

The drawings are for the purpose of illustrating example embodiments, but it is understood that the embodiments are not limited to the arrangements and instrumentality shown in the drawings.

### I. Overview

Rooms have certain acoustics which define how sound travels within the room. For example, a size and shape of the room may affect how sound reflects off a wall and ceiling of the room. As another example, types of surfaces in the room may affect how sound travels in the room. Hard surfaces such as wood or glass may reflect sound whereas soft surfaces such as leather or fabric may absorb sound.

An audio playback device may be located in the room. The audio playback device may have one or more speakers for playing audio content in the room. It may be desirable to calibrate (e.g., adjust) acoustics of the audio playback device so as to improve a listening experience in the room.

The calibration may be based on audio content played by the audio playback device. For example, the audio content may be music provided by a music content provider such as Spotify, Pandora, Amazon Music, among others, via a wide area network such as the Internet. The calibration may involve receiving a first stream of audio and a second stream of audio. The first stream of audio may be source audio content to be played back by the audio playback device. The second stream of audio may be a recording of an audio signal output by the audio playback device based on the audio playback device playing the source audio content. A frequency response of an audio playback device may be estimated based on the source audio content and the recording of the audio content, which may then be used to adjust acoustics of the audio playback device.

The calibration may be performed during a discrete or continuous calibration period. The discrete calibration period may be a calibration of the audio playback device that is performed as a result of a condition being met. For example, the condition may be that the audio playback device is being setup for use. Additionally, or alternatively, the condition may be that the audio playback device has not been calibrated before or a previous attempt to calibrate the audio playback device was unsuccessful. Still additionally, or alternatively, the condition may be that the audio playback device has moved or changed orientation. On the other hand, the continuous calibration period may be a calibration of the audio playback device that continues so long as the audio playback device plays audio content. Unlike the discrete calibration process, the calibration of the audio playback device may be generally ongoing and/or continuous, e.g., as a background process, while the audio playback device plays audio content.

The discrete or continuous calibration process may begin with the audio playback device playing source audio content. The source audio content may be spectral content such as music. The music may have frequencies substantially covering a render-able frequency range of the playback device, a detectable frequency range of the microphone, and/or an audible frequency range for an average human.

The playback of the source audio content may take the form of the audio playback device outputting an audio signal. This audio signal output by the playback device may be recorded.

The audio playback device may have a microphone in proximity to the audio playback device. For example, the microphone may be co-located physically on or in the playback device or wired or wirelessly connected to the audio playback device. This microphone may record the audio signal output by the audio playback device.

In another example, an audio signal output by the audio playback device may be recorded at a spatial location different from the spatial location of the audio playback device. The different spatial location may be where another device (such as a playback device, a controller device, or a network microphone device, among other examples) is located. Via its microphone, the other device may record the audio signal output by the audio playback device.

Acoustic echo cancellation is a process for cancelling reflected acoustic sounds from a speaker that are recorded by a microphone. The acoustic cancellation algorithm may be modified to determine a transfer function between a frequency response of the source audio content and a frequency response of the recorded audio signal output by the audio playback device. In turn, the transfer function and a self-response of the audio playback device in an anechoic chamber may be used to determine an estimated frequency response of the audio playback device. In the case of a controller device recording the audio signal output by the audio playback device, this estimated frequency response may be an approximation of the response curve as described in U.S. patent application Ser. No. 14/864,393, entitled “Facilitating Calibration of an Audio Playback Device”, the contents of which is herein incorporated by reference in its entirety. In the case of the audio playback device itself recording the audio signal output by the audio playback device, this estimated frequency response may represent a self-response of the audio playback device as described in U.S. patent application Ser. No. 15/096,827, entitled “Calibration of Audio Playback Devices”, the contents of which is herein incorporated by reference in its entirety. Other arrangements are also possible.

The estimated frequency response may be used to calibrate (e.g. adjust) acoustics of the audio playback device. For example, the estimated frequency response may be used to select an audio processing algorithm such as a filter or equalization to adjust acoustic settings of the audio playback device. U.S. patent application Ser. No. 14/481,511, entitled “Playback Device Calibration”, the contents of which is herein incorporated by reference in its entirety, discloses various audio processing algorithms to adjust acoustics of an audio playback device. The filter or equalization may be applied to audio content played by the audio playback device until such time that the filter or equalization is no longer valid or not needed.

In one example, functions associated with the disclosed calibration may be coordinated and at least partially performed by an audio playback device, such as one of the one or more audio playback devices to be calibrated for the playback environment. The audio playback device may calculate an estimated frequency response based on a first stream and second stream of audio and adjust acoustics of the audio playback device based on the estimated frequency response.

In another example, functions associated with the disclosed calibration may be coordinated and at least partially performed by a computing device. The computing device may be a server associated with a media playback system that includes one or more audio playback devices. The computing device may calculate an estimated frequency response based on a first stream and second stream of audio and adjust acoustics of the audio playback device based on the estimated frequency response.

In yet another example, functions associated with the disclosed calibration may be coordinated and at least partially performed by a controller device. The controller device may be used to control the audio playback device. The controller device may calculate an estimated frequency response based on a first stream and second stream of audio and adjust acoustics of the audio playback device based on the estimated frequency response.

Moving on from the above illustration, an example embodiment may include a method which comprises receiving, via a wide area network (WAN), a first stream of audio comprising source audio content to be played back by the audio playback device; receiving a second stream of audio comprising a recording of an audio signal output by the audio playback device based on the audio playback device playing the source audio content; calculating an estimated frequency response of the audio playback device based on the received first stream of audio and the received second stream of audio; and adjusting acoustics of the audio playback device based on the estimated frequency response. Calculating an estimated frequency response of an audio playback device based on the received first stream of audio and second stream of audio may comprise determining a transfer function between a frequency response of the first stream of audio and a frequency response of the second stream of audio. Determining a transfer function between a frequency response of the first stream of audio and a frequency response of the second stream of audio may comprise determining whether the transfer function has converged. The estimated frequency response of an audio playback device may be calculated based on an acoustic echo cancellation algorithm. Receiving, via a wide area network (WAN), a first stream of audio may comprise receiving, via the WAN, music from a music service provider. The method may further comprise determining that the audio playback device has moved. The estimated frequency response may be calculated in response to determining that the audio playback device has moved. The method may further comprise determining a spectral coverage of the source audio content prior to calculating the estimated frequency response. The method may further comprise playing back the source audio content based on the adjusted acoustics. The audio signal output by the audio playback device may be recorded at a spatial location different from the audio playback device. The audio signal output by the audio playback device may be recorded by the audio playback device.

Another example embodiment may include a tangible non-transitory computer readable storage medium including instructions executable by a processor to cause the processor to implement a method of receiving, via a wide area network (WAN), a first stream of audio comprising source audio content to be played back by the audio playback device; receiving a second stream of audio comprising a recording of an audio signal output by the audio playback device based on the audio playback device playing the source audio content; calculating an estimated frequency response of the audio playback device based on the received first stream of audio and the received second stream of audio; and adjusting acoustics of the audio playback device based on the estimated frequency response. The instructions for calculating an estimated frequency response of an audio playback device based on the received first stream of audio and second stream of audio may comprise determining a transfer function between a frequency response of the first stream of audio and a frequency response of the second stream of audio. The instructions for determining a transfer function between a frequency response of the first stream of audio and a frequency response of the second stream of audio may comprise determining whether the transfer function has converged. The tangible non-transitory computer readable storage may further comprise instructions for determining that the audio playback device has moved. The estimated frequency response may be calculated in response to determining that the audio playback device has moved. The tangible non-transitory computer readable storage may further comprise instructions for determining a spectral coverage of the source audio content prior to calculating the estimated frequency response. The tangible non-transitory computer readable storage may further comprise instructions for playing back the source audio content based on the adjusted acoustics. The audio signal output by the audio playback device may be recorded at a spatial location different from the audio playback device. The audio signal output by the audio playback device may be recorded by the audio playback device. The instructions for receiving, via a wide area network (WAN), a first stream of audio may comprise receiving music from a music service provider via the WAN. The estimated frequency response of an audio playback device may be calculated based on an acoustic echo cancellation algorithm.

### II. Example Operating Environment

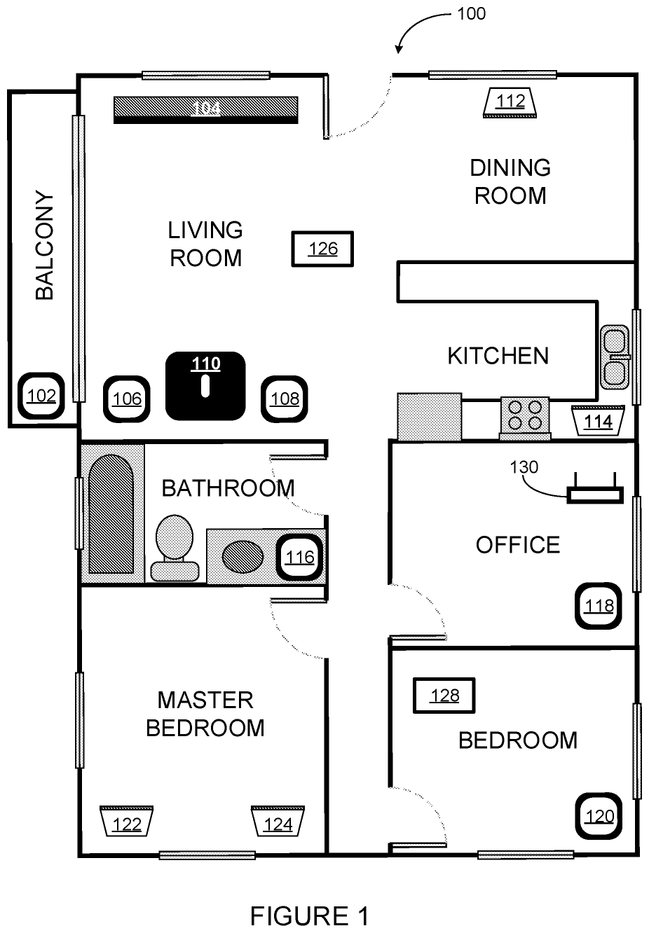

FIG. 1 shows an example configuration of a media playback system 100 in which one or more embodiments disclosed herein may be practiced or implemented. The media playback system 100 as shown is associated with an example home environment having several rooms and spaces, such as for example, a master bedroom, an office, a dining room, and a living room. As shown in the example of FIG. 1, the media playback system 100 includes playback devices 102-124, control devices 126 and 128, and a wired or wireless network router 130.

Further discussions relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

a. Example Playback Devices

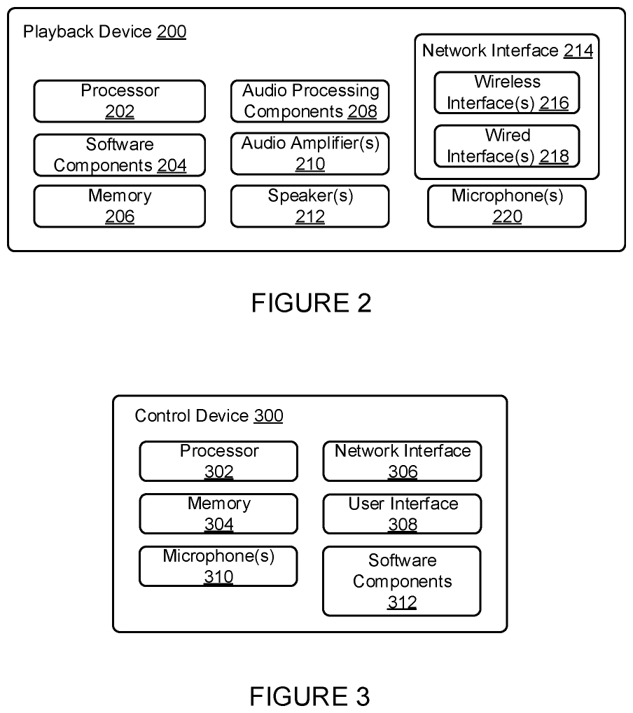

FIG. 2 shows a functional block diagram of an example playback device 200 that may be configured to be one or more of the playback devices 102-124 of the media playback system 100 of FIG. 1. The playback device 200 may include a processor 202, software components 204, memory 206, audio processing components 208, audio amplifier(s) 210, speaker(s) 212, a network interface 214 including wireless interface(s) 216 and wired interface(s) it 218, and microphone(s) 220. In one case, the playback device 200 may not include the speaker(s) 212, but rather a speaker interface for connecting the playback device 200 to external speakers. In another case, the playback device 200 may include neither the speaker(s) 212 nor the audio amplifier(s) 210, but rather an audio interface for connecting the playback device 200 to an external audio amplifier or audio-visual receiver.

In one example, the processor 202 may be a clock-driven computing component configured to process input data according to instructions stored in the memory 206. The memory 206 may be a tangible computer-readable medium configured to store instructions executable by the processor 202. For instance, the memory 206 may be data storage that can be loaded with one or more of the software components 204 executable by the processor 202 to achieve certain functions. In one example, the functions may involve the playback device 200 retrieving audio data from an audio source or another playback device. In another example, the functions may involve the playback device 200 sending audio data to another device or playback device on a network. In yet another example, the functions may involve pairing of the playback device 200 with one or more playback devices to create a multi-channel audio environment.

Certain functions may involve the playback device 200 synchronizing playback of audio content with one or more other playback devices. During synchronous playback, a listener will preferably not be able to perceive time-delay differences between playback of the audio content by the playback device 200 and the one or more other playback devices. U.S. Pat. No. 8,234,395 entitled, “System and method for synchronizing operations among a plurality of independently clocked digital data processing devices,” which is hereby incorporated by reference, provides in more detail some examples for audio playback synchronization among playback devices.

The memory 206 may further be configured to store data associated with the playback device 200, such as one or more zones and/or zone groups the playback device 200 is a part of, audio sources accessible by the playback device 200, or a playback queue that the playback device 200 (or some other playback device) may be associated with. The data may be stored as one or more state variables that are periodically updated and used to describe the state of the playback device 200. The memory 206 may also include the data associated with the state of the other devices of the media system, and shared from time to time among the devices so that one or more of the devices have the most recent data associated with the system. Other embodiments are also possible.

The audio processing components 208 may include one or more digital-to-analog converters (DAC), an audio preprocessing component, an audio enhancement component or a digital signal processor (DSP), and so on. In one embodiment, one or more of the audio processing components 208 may be a subcomponent of the processor 202. In one example, audio content may be processed and/or intentionally altered by the audio processing components 208 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback by the playback device 200, the audio processing components 208 may be configured to process audio content to be sent to one or more other playback devices for playback.

Audio content to be processed and/or played back by the playback device 200 may be received from an external source, such as via an audio line-in input connection (e.g., an auto-detecting 3.5 mm audio line-in connection) or the network interface 214.

The network interface 214 may be configured to facilitate a data flow between the playback device 200 and one or more other devices on a data network. As such, the playback device 200 may be configured to receive audio content over the data network from one or more other playback devices in communication with the playback device 200, network devices within a local area network, or audio content sources over a wide area network such as the Internet. In one example, the audio content and other signals transmitted and received by the playback device 200 may be transmitted in the form of digital packet data containing an Internet Protocol (IP)-based source address and IP-based destination addresses. In such a case, the network interface 214 may be configured to parse the digital packet data such that the data destined for the playback device 200 is properly received and processed by the playback device 200.

As shown, the network interface 214 may include wireless interface(s) 216 and wired interface(s) 218. The wireless interface(s) 216 may provide network interface functions for the playback device 200 to wirelessly communicate with other devices (e.g., other playback device(s), speaker(s), receiver(s), network device(s), control device(s) within a data network the playback device 200 is associated with) in accordance with a communication protocol (e.g., any wireless standard including IEEE 802.11a, 802.11b, 802.11 g, 802.11n, 802.11ac, 802.15, 4G mobile communication standard, and so on). The wired interface(s) 218 may provide network interface functions for the playback device 200 to communicate over a wired connection with other devices in accordance with a communication protocol (e.g., IEEE 802.3). While the network interface 214 shown in FIG. 2 includes both wireless interface(s) 216 and wired interface(s) 218, the network interface 214 may in some embodiments include only wireless interface(s) or only wired interface(s).

The microphone(s) 220 may be arranged to detect sound in the environment of the playback device 200. For instance, the microphone(s) may be mounted on an exterior wall of a housing of the playback device. The microphone(s) may be any type of microphone now known or later developed such as a condenser microphone, electret condenser microphone, or a dynamic microphone. The microphone(s) may be sensitive to a portion of the frequency range of the speaker(s) 220. One or more of the speaker(s) 220 may operate in reverse as the microphone(s) 220. In some aspects, the playback device 200 might not have microphone(s) 220.

In one example, the playback device 200 and one other playback device may be paired to play two separate audio components of audio content. For instance, playback device 200 may be configured to play a left channel audio component, while the other playback device may be configured to play a right channel audio component, thereby producing or enhancing a stereo effect of the audio content. The paired playback devices (also referred to as “bonded playback devices”) may further play audio content in synchrony with other playback devices.

In another example, the playback device 200 may be sonically consolidated with one or more other playback devices to form a single, consolidated playback device. A consolidated playback device may be configured to process and reproduce sound differently than an unconsolidated playback device or playback devices that are paired, because a consolidated playback device may have additional speaker drivers through which audio content may be rendered. For instance, if the playback device 200 is a playback device designed to render low frequency range audio content (i.e. a subwoofer), the playback device 200 may be consolidated with a playback device designed to render full frequency range audio content. In such a case, the full frequency range playback device, when consolidated with the low frequency playback device 200, may be configured to render only the mid and high frequency components of audio content, while the low frequency range playback device 200 renders the low frequency component of the audio content. The consolidated playback device may further be paired with a single playback device or yet another consolidated playback device.

By way of illustration, SONOS, Inc. presently offers (or has offered) for sale certain playback devices including a “PLAY: 1,” “PLAY: 3,” “PLAY: 5,” “PLAYBAR,” “CONNECT: AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2 or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

b. Example Playback Zone Configurations

Referring back to the media playback system 100 of FIG. 1, the environment may have one or more playback zones, each with one or more playback devices. The media playback system 100 may be established with one or more playback zones, after which one or more zones may be added, or removed to arrive at the example configuration shown in FIG. 1. Each zone may be given a name according to a different room or space such as an office, bathroom, master bedroom, bedroom, kitchen, dining room, living room, and/or balcony. In one case, a single playback zone may include multiple rooms or spaces. In another case, a single room or space may include multiple playback zones.

As shown in FIG. 1, the balcony, dining room, kitchen, bathroom, office, and bedroom zones each have one playback device, while the living room and master bedroom zones each have multiple playback devices. In the living room zone, playback devices 104, 106, 108, and 110 may be configured to play audio content in synchrony as individual playback devices, as one or more bonded playback devices, as one or more consolidated playback devices, or any combination thereof. Similarly, in the case of the master bedroom, playback devices 122 and 124 may be configured to play audio content in synchrony as individual playback devices, as a bonded playback device, or as a consolidated playback device.

In one example, one or more playback zones in the environment of FIG. 1 may each be playing different audio content. For instance, the user may be grilling in the balcony zone and listening to hip hop music being played by the playback device 102 while another user may be preparing food in the kitchen zone and listening to classical music being played by the playback device 114. In another example, a playback zone may play the same audio content in synchrony with another playback zone. For instance, the user may be in the office zone where the playback device 118 is playing the same rock music that is being playing by playback device 102 in the balcony zone. In such a case, playback devices 102 and 118 may be playing the rock music in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified, and in some embodiments, the media playback system 100 supports numerous configurations. For instance, if a user physically moves one or more playback devices to or from a zone, the media playback system 100 may be reconfigured to accommodate the change(s). For instance, if the user physically moves the playback device 102 from the balcony zone to the office zone, the office zone may now include both the playback device 118 and the playback device 102. The playback device 102 may be paired or grouped with the office zone and/or renamed if so desired via a control device such as the control devices 126 and 128. On the other hand, if the one or more playback devices are moved to a particular area in the home environment that is not already a playback zone, a new playback zone may be created for the particular area.

Further, different playback zones of the media playback system 100 may be dynamically combined into zone groups or split up into individual playback zones. For instance, the dining room zone and the kitchen zone 114 may be combined into a zone group for a dinner party such that playback devices 112 and 114 may render audio content in synchrony. On the other hand, the living room zone may be split into a television zone including playback device 104, and a listening zone including playback devices 106, 108, and 110, if the user wishes to listen to music in the living room space while another user wishes to watch television.

c. Example Control Devices

FIG. 3 shows a functional block diagram of an example control device 300 that may be configured to be one or both of the control devices 126 and 128 of the media playback system 100. As shown, the control device 300 may include a processor 302, memory 304, a network interface 306, a user interface 308, microphone(s) 310, and software components 312. In one example, the control device 300 may be a dedicated controller for the media playback system 100. In another example, the control device 300 may be a network device on which media playback system controller application software may be installed, such as for example, an iPhone™, iPad™ or any other smart phone, tablet or network device (e.g., a networked computer such as a PC or Mac™).

The processor 302 may be configured to perform functions relevant to facilitating user access, control, and configuration of the media playback system 100. The memory 304 may be data storage that can be loaded with one or more of the software components executable by the processor 302 to perform those functions. The memory 304 may also be configured to store the media playback system controller application software and other data associated with the media playback system 100 and the user.

In one example, the network interface 306 may be based on an industry standard (e.g., infrared, radio, wired standards including IEEE 802.3, wireless standards including IEEE 802.11a, 802.11b, 802.11 g, 802.11n, 802.11ac, 802.15, 4G mobile communication standard, and so on). The network interface 306 may provide a means for the control device 300 to communicate with other devices in the media playback system 100. In one example, data and information (e.g., such as a state variable) may be communicated between control device 300 and other devices via the network interface 306. For instance, playback zone and zone group configurations in the media playback system 100 may be received by the control device 300 from a playback device or another network device, or transmitted by the control device 300 to another playback device or network device via the network interface 306. In some cases, the other network device may be another control device.

Playback device control commands such as volume control and audio playback control may also be communicated from the control device 300 to a playback device via the network interface 306. As suggested above, changes to configurations of the media playback system 100 may also be performed by a user using the control device 300. The configuration changes may include adding/removing one or more playback devices to/from a zone, adding/removing one or more zones to/from a zone group, forming a bonded or consolidated player, separating one or more playback devices from a bonded or consolidated player, among others. Accordingly, the control device 300 may sometimes be referred to as a controller, whether the control device 300 is a dedicated controller or a network device on which media playback system controller application software is installed.

Control device 300 may include microphone(s) 310. Microphone(s) 310 may be arranged to detect sound in the environment of the control device 300. Microphone(s) 310 may be any type of microphone now known or later developed such as a condenser microphone, electret condenser microphone, or a dynamic microphone. The microphone(s) may be sensitive to a portion of a frequency range. Two or more microphones 310 may be arranged to capture location information of an audio source (e.g., voice, audible sound) and/or to assist in filtering background noise.

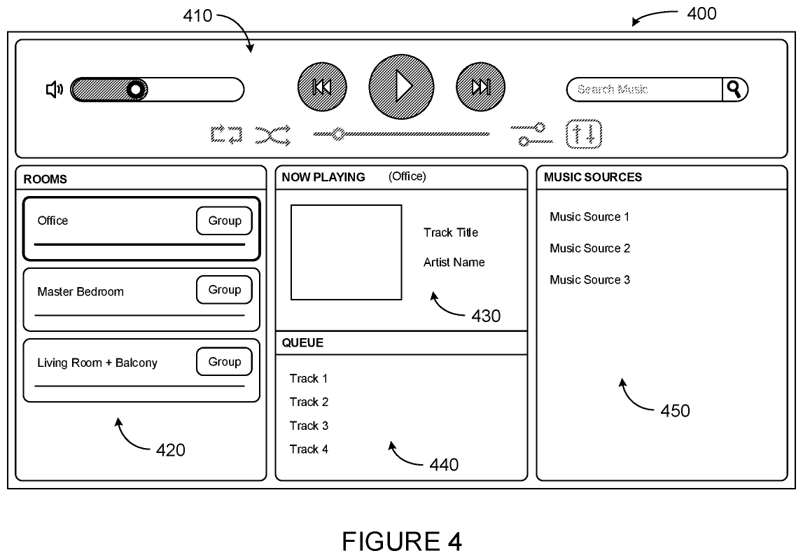

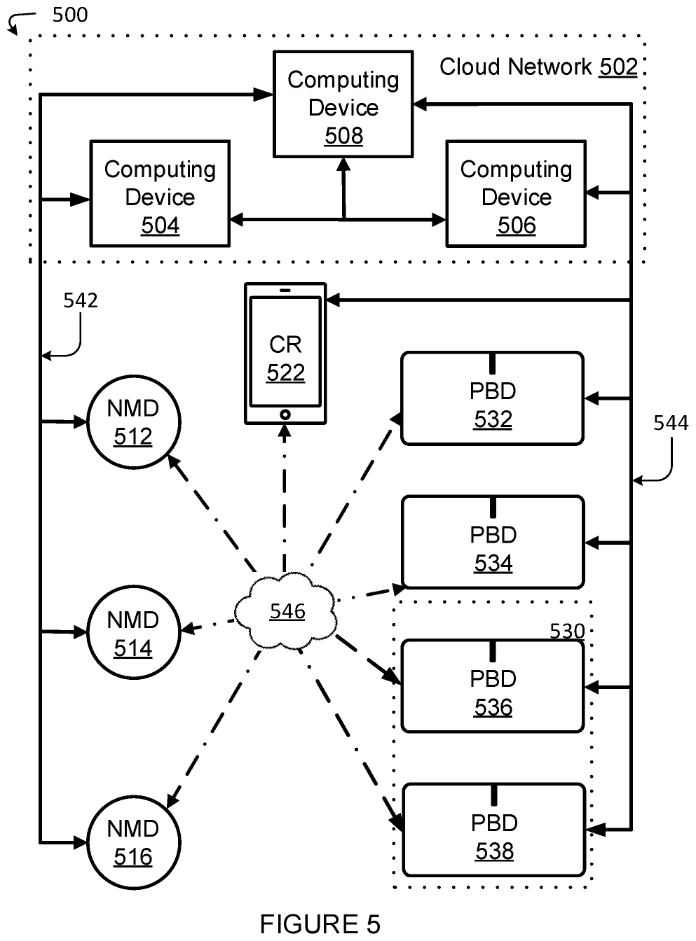

The user interface 308 of the control device 300 may be configured to facilitate user access and control of the media playback system 100, by providing a controller interface such as the controller interface 400 shown in FIG. 4. The controller interface 400 includes a playback control region 410, a playback zone region 420, a playback status region 430, a playback queue region 440, and an audio content sources region 450. The user interface 400 as shown is just one example of a user interface that may be provided on a network device such as the control device 300 of FIG. 3 (and/or the control devices 126 and 128 of FIG. 1) and accessed by users to control a media playback system such as the media playback system 100. Other user interfaces of varying formats, styles, and interactive sequences may alternatively be implemented on one or more network devices to provide comparable control access to a media playback system.

The playback control region 410 may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 410 may also include selectable icons to modify equalization settings, and playback volume, among other possibilities.

The playback zone region 420 may include representations of playback zones within the media playback system 100. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the user interface 400 are also possible. The representations of playback zones in the playback zone region 420 may be dynamically updated as playback zone or zone group configurations are modified.

The playback status region 430 may include graphical representations of audio content that is presently being played, previously played, or scheduled to play next in the selected playback zone or zone group. The selected playback zone or zone group may be visually distinguished on the user interface, such as within the playback zone region 420 and/or the playback status region 430. The graphical representations may include track title, artist name, album name, album year, track length, and other relevant information that may be useful for the user to know when controlling the media playback system via the user interface 400.

The playback queue region 440 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

Referring back to the user interface 400 of FIG. 4, the graphical representations of audio content in the playback queue region 440 may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device.

The audio content sources region 450 may include graphical representations of selectable audio content sources from which audio content may be retrieved and played by the selected playback zone or zone group. Discussions pertaining to audio content sources may be found in the following section.

d. Example Audio Content Sources

As indicated previously, one or more playback devices in a zone or zone group may be configured to retrieve for playback audio content (e.g. according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a control device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

c. Example Plurality of Networked Devices

FIG. 5 shows an example plurality of devices 500 that may be configured to provide an audio playback experience based on voice control. One having ordinary skill in the art will appreciate that the devices shown in FIG. 5 are for illustrative purposes only, and variations including different and/or additional devices may be possible. As shown, the plurality of devices 500 includes computing devices 504, 506, and 508; network microphone devices (NMDs) 512, 514, and 516; playback devices (PBDs) 532, 534, 536, and 538; and a controller device (CR) 522.

Each of the plurality of devices 500 may be network-capable devices that can establish communication with one or more other devices in the plurality of devices according to one or more network protocols, such as NFC, Bluetooth, Ethernet, and IEEE 802.11, among other examples, over one or more types of networks, such as wide area networks (WAN), local area networks (LAN), and personal area networks (PAN), among other possibilities.

As shown, the computing devices 504, 506, and 508 may be part of a cloud network 502. The cloud network 502 may include additional computing devices. In one example, the computing devices 504, 506, and 508 may be different servers. In another example, two or more of the computing devices 504, 506, and 508 may be modules of a single server. Analogously, each of the computing device 504, 506, and 508 may include one or more modules or servers. For case of illustration purposes herein, each of the computing devices 504, 506, and 508 may be configured to perform particular functions within the cloud network 502. For instance, computing device 508 may be a source of audio content for a streaming music service.

As shown, the computing device 504 may be configured to interface with NMDs 512, 514, and 516 via communication path 542. NMDs 512, 514, and 516 may be components of one or more “Smart Home” systems. In one case, NMDs 512, 514, and 516 may be physically distributed throughout a household, similar to the distribution of devices shown in FIG. 1. In another case, two or more of the NMDs 512, 514, and 516 may be physically positioned within relative close proximity of one another. Communication path 542 may comprise one or more types of networks, such as a WAN including the Internet, LAN, and/or PAN, among other possibilities.

In one example, one or more of the NMDs 512, 514, and 516 may be devices configured primarily for audio detection. In another example, one or more of the NMDs 512, 514, and 516 may be components of devices having various primary utilities. For instance, as discussed above in connection to FIGS. 2 and 3, one or more of NMDs 512, 514, and 516 may be the microphone(s) 220 of playback device 200 or the microphone(s) 310 of network device 300. Further, in some cases, one or more of NMDs 512, 514, and 516 may be the playback device 200 or network device 300. In an example, one or more of NMDs 512, 514, and/or 516 may include multiple microphones arranged in a microphone array.

As shown, the computing device 506 may be configured to interface with CR 522 and PBDs 532, 534, 536, and 538 via communication path 544. In one example, CR 522 may be a network device such as the network device 200 of FIG. 2. Accordingly, CR 522 may be configured to provide the controller interface 400 of FIG. 4. Similarly, PBDs 532, 534, 536, and 538 may be playback devices such as the playback device 300 of FIG. 3. As such, PBDs 532, 534, 536, and 538 may be physically distributed throughout a household as shown in FIG. 1. For illustration purposes, PBDs 536 and 538 may be part of a bonded zone 530, while PBDs 532 and 534 may be part of their own respective zones. As described above, the PBDs 532, 534, 536, and 538 may be dynamically bonded, grouped, unbonded, and ungrouped. Communication path 544 may comprise one or more types of networks, such as a WAN including the Internet, LAN, and/or PAN, among other possibilities.

In one example, as with NMDs 512, 514, and 516, CR522 and PBDs 532, 534, 536, and 538 may also be components of one or more “Smart Home” systems. In one case, PBDs 532, 534, 536, and 538 may be distributed throughout the same household as the NMDs 512, 514, and 516. Further, as suggested above, one or more of PBDs 532, 534, 536, and 538 may be one or more of NMDs 512, 514, and 516.

The NMDs 512, 514, and 516 may be part of a local area network, and the communication path 542 may include an access point that links the local area network of the NMDs 512, 514, and 516 to the computing device 504 over a WAN (communication path not shown). Likewise, each of the NMDs 512, 514, and 516 may communicate with each other via such an access point.

Similarly, CR 522 and PBDs 532, 534, 536, and 538 may be part of a local area network and/or a local playback network as discussed in previous sections, and the communication path 544 may include an access point that links the local area network and/or local playback network of CR 522 and PBDs 532, 534, 536, and 538 to the computing device 506 over a WAN. As such, each of the CR 522 and PBDs 532, 534, 536, and 538 may also communicate with each over such an access point.

In one example, communication paths 542 and 544 may comprise the same access point. In an example, each of the NMDs 512, 514, and 516, CR 522, and PBDs 532, 534, 536, and 538 may access the cloud network 502 via the same access point for a household.

As shown in FIG. 5, each of the NMDs 512, 514, and 516, CR 522, and PBDs 532, 534, 536, and 538 may also directly communicate with one or more of the other devices via communication means 546. Communication means 546 as described herein may involve one or more forms of communication between the devices, according to one or more network protocols, over one or more types of networks, and/or may involve communication via one or more other network devices. For instance, communication means 546 may include one or more of for example, Bluetooth™ (IEEE 802.15), NFC, Wireless direct, and/or Proprietary wireless, among other possibilities.

In one example, CR 522 may communicate with NMD 512 over Bluetooth™, and communicate with PBD 534 over another local area network. In another example, NMD 514 may communicate with CR 522 over another local area network, and communicate with PBD 536 over Bluetooth. In a further example, each of the PBDs 532, 534, 536, and 538 may communicate with each other according to a spanning tree protocol over a local playback network, while each communicating with CR 522 over a local area network, different from the local playback network. Other examples are also possible.

In some cases, communication means between the NMDs 512, 514, and 516, CR 522, and PBDs 532, 534, 536, and 538 may change depending on types of communication between the devices, network conditions, and/or latency demands. For instance, communication means 546 may be used when NMD 516 is first introduced to the household with the PBDs 532, 534, 536, and 538. In one case, the NMD 516 may transmit identification information corresponding to the NMD 516 to PBD 538 via NFC, and PBD 538 may in response, transmit local area network information to NMD 516 via NFC (or some other form of communication). However, once NMD 516 has been configured within the household, communication means between NMD 516 and PBD 538 may change. For instance, NMD 516 may subsequently communicate with PBD 538 via communication path 542, the cloud network 502, and communication path 544. In another example, the NMDs and PBDs may never communicate via local communications means 546. In a further example, the NMDs and PBDs may communicate primarily via local communications means 546. Other examples are also possible.

In an illustrative example, NMDs 512, 514, and 516 may be configured to receive voice inputs to control PBDs 532, 534, 536, and 538. The available control commands may include any media playback system controls previously discussed, such as playback volume control, playback transport controls, music source selection, and grouping, among other possibilities. In one instance, NMD 512 may receive a voice input to control one or more of the PBDs 532, 534, 536, and 538. In response to receiving the voice input, NMD 512 may transmit via communication path 542, the voice input to computing device 504 for processing. In one example, the computing device 504 may convert the voice input to an equivalent text command, and parse the text command to identify a command. Computing device 504 may then subsequently transmit the text command to the computing device 506. In another example, the computing device 504 may convert the voice input to an equivalent text command, and then subsequently transmit the text command to the computing device 506. The computing device 506 may then parse the text command to identify one or more playback commands.

For instance, if the text command is “Play ‘Track 1’ by ‘Artist 1’ from ‘Streaming Service 1’ in ‘Zone 1’,” The computing device 506 may identify (i) a URL for “Track 1” by “Artist 1” available from “Streaming Service 1,” and (ii) at least one playback device in “Zone 1.” In this example, the URL for “Track 1” by “Artist 1” from “Streaming Service 1” may be a URL pointing to computing device 508, and “Zone 1” may be the bonded zone 530. As such, upon identifying the URL and one or both of PBDs 536 and 538, the computing device 506 may transmit via communication path 544 to one or both of PBDs 536 and 538, the identified URL for playback. One or both of PBDs 536 and 538 may responsively retrieve audio content from the computing device 508 according to the received URL, and begin playing “Track 1” by “Artist 1” from “Streaming Service 1.”

One having ordinary skill in the art will appreciate that the above is just one illustrative example, and that other implementations are also possible. In one case, operations performed by one or more of the plurality of devices 500, as described above, may be performed by one or more other devices in the plurality of device 500. For instance, the conversion from voice input to the text command may be alternatively, partially, or wholly performed by another device or devices, such as NMD 512, computing device 506, PBD 536, and/or PBD 538. Analogously, the identification of the URL may be alternatively, partially, or wholly performed by another device or devices, such as NMD 512, computing device 504, PBD 536, and/or PBD 538.

f. Example Network Microphone Device

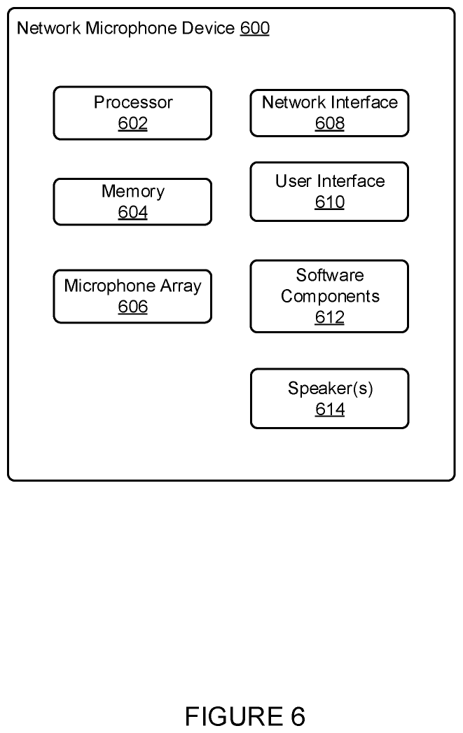

FIG. 6 shows a function block diagram of an example network microphone device 600 that may be configured to be one or more of NMDs 512, 514, and 516 of FIG. 5. As shown, the network microphone device 600 includes a processor 602, memory 604, a microphone array 606, a network interface 608, a user interface 610, software components 612, and speaker(s) 614. One having ordinary skill in the art will appreciate that other network microphone device configurations and arrangements are also possible. For instance, network microphone devices may alternatively exclude the speaker(s) 614 or have a single microphone instead of microphone array 606.

The processor 602 may include one or more processors and/or controllers, which may take the form of a general or special-purpose processor or controller. For instance, the processing unit 602 may include microprocessors, microcontrollers, application-specific integrated circuits, digital signal processors, and the like. The memory 604 may be data storage that can be loaded with one or more of the software components executable by the processor 602 to perform those functions. Accordingly, memory 604 may comprise one or more non-transitory computer-readable storage mediums, examples of which may include volatile storage mediums such as random access memory, registers, cache, etc. and non-volatile storage mediums such as read-only memory, a hard-disk drive, a solid-state drive, flash memory, and/or an optical-storage device, among other possibilities.

The microphone array 606 may be a plurality of microphones arranged to detect sound in the environment of the network microphone device 600. Microphone array 606 may include any type of microphone now known or later developed such as a condenser microphone, electret condenser microphone, or a dynamic microphone, among other possibilities. In one example, the microphone array may be arranged to detect audio from one or more directions relative to the network microphone device. The microphone array 606 may be sensitive to a portion of a frequency range. In one example, a first subset of the microphone array 606 may be sensitive to a first frequency range, while a second subset of the microphone array may be sensitive to a second frequency range. The microphone array 606 may further be arranged to capture location information of an audio source (e.g., voice, audible sound) and/or to assist in filtering background noise. Notably, in some embodiments the microphone array may consist of only a single microphone, rather than a plurality of microphones.

The network interface 608 may be configured to facilitate wireless and/or wired communication between various network devices, such as, in reference to FIG. 5, CR 522, PBDs 532-538, computing device 504-508 in cloud network 502, and other network microphone devices, among other possibilities. As such, network interface 608 may take any suitable form for carrying out these functions, examples of which may include an Ethernet interface, a serial bus interface (e.g., FireWire, USB 2.0, etc.), a chipset and antenna adapted to facilitate wireless communication, and/or any other interface that provides for wired and/or wireless communication. In one example, the network interface 608 may be based on an industry standard (e.g., infrared, radio, wired standards including IEEE 802.3, wireless standards including IEEE 802.11a, 802.11b, 802.11 g, 802.11n, 802.11ac, 802.15, 4G mobile communication standard, and so on).

The user interface 610 of the network microphone device 600 may be configured to facilitate user interactions with the network microphone device. In one example, the user interface 608 may include one or more of physical buttons, graphical interfaces provided on touch sensitive screen(s) and/or surface(s), among other possibilities, for a user to directly provide input to the network microphone device 600. The user interface 610 may further include one or more of lights and the speaker(s) 614 to provide visual and/or audio feedback to a user. In one example, the network microphone device 600 may further be configured to playback audio content via the speaker(s) 614.

### III. Example Systems

Embodiments described herein involve calibrating (e.g., adjusting) acoustics of an audio playback device for an environment, e.g., room, in which the audio playback device is located based on an estimated frequency response of the audio playback device.

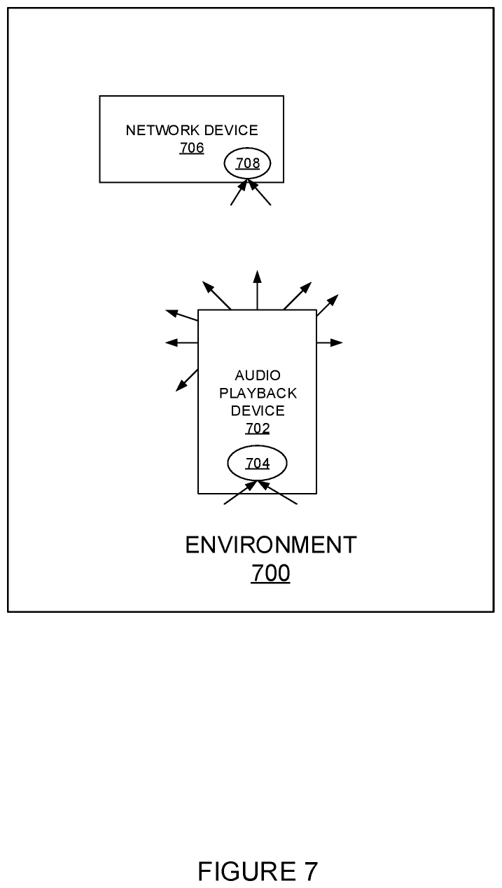

FIG. 7 illustrates such an example environment 700 in which the audio playback device may be calibrated in accordance with disclosed embodiments. The example environment may be, for example, a living room or bedroom of a home. The environment 700 may have an audio playback device 702 capable of outputting audio content in one or more directions via one or more speakers. In embodiments, the audio content may not be limited to one or more predetermined test tones at one or more frequencies, but may include spectral content which may take the form of one or more of digital or analog music, television audio, and radio. The spectral content may be provided by the computing device 508 via the cloud network 502. For example, the computing device may be a music service provider such as Spotify, Amazon Music, Pandora, among others, and the cloud network may be a wide area network (WAN) such as the Internet. The audio content may have frequencies substantially covering a renderable frequency range of the playback device, a detectable frequency range of the microphone, and/or an audible frequency range for an average human.

The audio playback device 702 may have one or more microphones 704 for recording an audio signal output by the audio playback device. The one or more microphones 704 may be proximate to the audio playback device. For example, the microphone may be co-located physically on or in the playback device or wired or wirelessly connected to the audio playback device. The audio signal output by the audio playback device recorded at the audio playback device may be used to determine an estimated frequency response of the audio playback device (i.e., a self-response). The self-response may be used to calibrate the audio playback device.

The room 700 may also have one or more network devices 706. The network device 706 may be a controller device, NMD, or another audio playback device. The network device 706 may have one or more microphones 708 for recording an audio signal output by the audio playback device 702 at a spatial location in the environment 700 different from the spatial location of the audio playback device 702. The different location might be in front of the audio playback device 702, behind the audio playback device 702, or adjacent to the audio playback device 702. The audio signal output by the audio playback device recorded at the network device may be used to determine an estimated frequency response of the audio playback device (i.e., a test response). The test response may be used to calibrate the audio playback device.

In some embodiments, the network device 706 may also be physically movable. In this regard, the microphone of the network device 706 may record the audio signal output by the audio playback device 702 at one or more spatial locations in the environment. For example, the controller device may be physically moved to one or more spatial locations in the environment and the microphone of the controller device may record the audio signal output by the audio playback device 702. Alternatively, a wired or wireless microphone of the audio playback device 702 may be moved to the different spatial locations to record the audio signal output by the audio playback device 702 in a manner similar to that of the controller device. Still alternatively, an NMD may be moved to various spatial locations in the environment to record the audio signal output by the audio playback device 702. Additionally, or alternatively, a plurality of NMDs fixed at various locations in the room may be used to record the audio signal output by the audio playback device 702 at different spatial locations in the room rather than physically moving the NMD in the environment 700. The recorded audio signal output by the audio playback device may be used to determine an estimated frequency response of the audio playback device. The estimated frequency response may be used to calibrate (e.g., adjust) acoustics of the audio playback device.

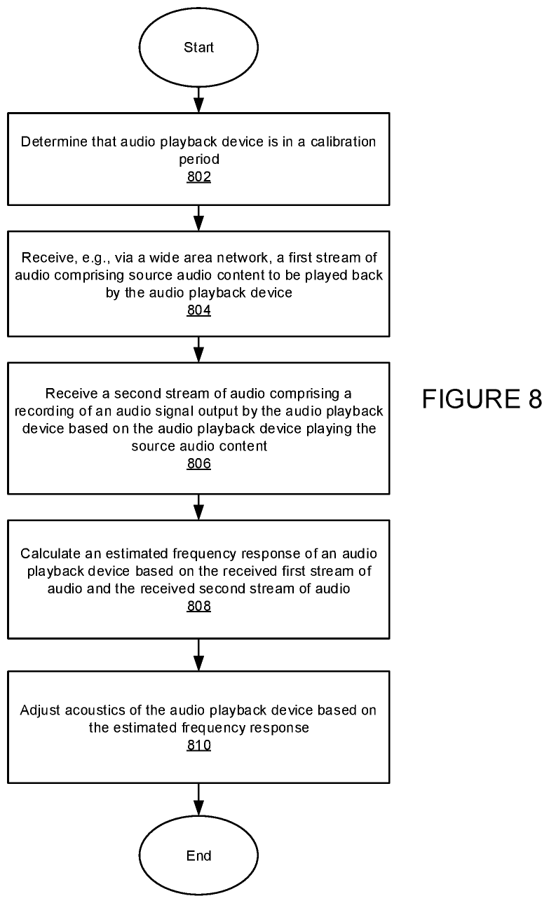

FIG. 8 shows an example flow diagram of functions associated with calibrating a playback device in accordance with the disclosed embodiments. Methods and the other process disclosed herein may include one or more operations, functions, or actions. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the methods and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, each block in the figures may represent circuitry that is wired to perform the specific logical functions in the process.

In one example, the disclosed functions for the calibration may be at least partially performed by the audio playback device 200. In another example, the disclosed functions for the calibration may be at least partially performed by the computing device 504-508. In yet another example, functions for the calibration may be at least partially performed by the controller device 300. In another example, functions for the calibration may be at least partially performed by an NMD 512-516. Other arrangements are also possible.

Briefly, at 802, a determination is made that the audio playback device is in a calibration period. At 804, a first stream of audio is received, e.g., via a wide area network. The first stream of audio comprises source audio content to be played back by the audio playback device. At 806, a second stream of audio is received. The second stream of audio comprises a recording of an audio signal output by the audio playback device based on the audio playback device playing the source audio content. At 808, an estimated frequency response of an audio playback device is calculated based on the received first stream of audio and the received second stream of audio. At 810, acoustics of the audio playback device is adjusted based on the estimated frequency response. The functions of the example process shown in FIG. 8 will now be described in further detail.

Starting at 802, a determination is made that the audio playback device is in a calibration period. The calibration period may be a time when the audio content output by the playback device may be calibrated. The calibration period may take the form of a discrete or a continuous calibration period.

The discrete calibration period may be a calibration which occurs when a condition is satisfied. For example, the condition may be that a user is setting up or configuring the audio playback device for a first time or after being reset. Alternatively, the condition may be a determination that a calibration has not been performed before on the audio playback device. Still alternatively, the condition may be a determination that a previous calibration is invalid or a previous calibration attempt on the playback device was unsuccessful. For example, the condition may be a time elapsed since a last calibration of the audio playback device or after a “break in” period of the audio playback device. The “break in” period may be the period of time until acoustic components of a speaker such as the cones, diaphragms, and/or drivers move freely and experience a full range of motion. The condition associated with calibration period may be met once the “break in” period is complete.

Movement and/or change in orientation of the audio playback device may also be a condition for triggering calibration. Movement may be a change in spatial location of the audio playback device. Change in orientation may be a change in angular position of the audio playback device. For example, the audio playback device may be not longer resting parallel with a supporting surface such as a shelf but rather angled upwards or downwards. The change in orientation may result in the audio playback device outputting audio on one direction versus another direction. Additionally, or alternatively, the change in orientation may be a rotation of the audio playback device. For example, the audio playback device may be rotated by 90 degrees so that the audio playback device rests on one of its sides rather than another of its sides. Movement and/or change in orientation of the device may be suggestive of a change in an acoustic response of the audio playback device and a need for calibration.

In one example, the audio playback device may be equipped with a sensor such as an accelerometer, global positioning system (GPS), and/or gyroscope for detecting movement and/or a change in orientation of the audio playback device. The sensor may output a signal when the audio playback device moves or changes orientation. In another example, the audio playback device may have an IP address associated with its current location. If the audio playback device is disconnected from the communication means 546 and then reconnected, e.g., it is moved from a bedroom to a living room, the audio playback device may be assigned a new IP address. A change in the IP address may indicate that the audio playback device has moved. In still another example, a change in a label of the audio playback device may indicate that the audio playback device has moved. The audio playback device may be labeled such as “Bedroom Device” or “Living Room Device” to facilitate identification of the audio playback device by a user. A change in the label of the audio playback device, e.g., from “Bedroom Device” to “Living Room Device” may be indicative of the audio playback device being moved.

In some configurations, a change in bonding of the audio playback device may be a condition for triggering calibration. The audio playback device may be bonded to one or more other playback devices to form a bonded zone. The bonded zone may represent one or more audio playback devices playing audio in synchrony. Calibration may be triggered if the audio playback device is bonded with another one or more playback devices and in the new bond the audio playback device changes its equalization, spatial, and/or temporal response. The equalization response may define adjustments to frequencies output by the playback device. The spatial response may define a direction in which the audio content is directed, e.g., using beamforming techniques. The temporal response may define a phase of the audio played by the playback device.

The audio playback device may refer to a state variable in determining whether to trigger the calibration. The state variable may define a state of the audio playback device. For example, the state variable may indicate a position/orientation of the device. A change in position/orientation indicated by the state variable suggests that the playback device moved. As another example, the state variable may indicate which devices a playback device is bonded to. A change in the bonded device(s) may indicate a change in bonding. As yet another example, the state variable may indicate whether the playback device has been set up, calibrated previously, or when it was last calibrated. The state variable may indicate other states of the audio playback device as well. The state variable may be maintained at the audio playback device, the controller device, and/or computing device and exchanged among audio playback devices via the communications means 546.

The continuous calibration process may be a calibration of the audio playback device which continues so long as the playback device plays audio content. The continuous calibration process may normally run as a background process while the audio playback device plays back audio content.

The continuous calibration may be suspended in some instances. In one example, the continuous calibration may be suspended when non-linearities are introduced during signal processing of the source audio content. Such non-linearities could occur at upper and lower volume range extremes. The non-linearities may degrade a signal to noise ratio of the audio signal output by the audio playback device. In this regard, non-linearities in processing the source audio content may determine whether continuous calibration is performed.

As another example, a magnitude of an audio signal output by the audio playback device may cause the continuous calibration to be suspended. A volume setting of an audio playback device may be compared to a threshold level. If the volume setting of the audio playback device is below the threshold level, then a signal to noise ratio of the audio signal output by the audio playback device may be too low to perform the continuous calibration. The volume setting that is compared may be the actual volume setting or a filtered volume setting such as an average volume setting. Additionally, or alternatively, if a sound level of the source audio content is below a threshold level, then a signal to noise ratio of the audio signal output by the audio playback device may be too low to perform the continuous calibration. A magnitude of digital samples of the source audio content may define the sound level of the source audio content. The sound level that is compared to the threshold may be the actual sound level or a filtered sound level such as an average sound level.

The source audio content may span a frequency range from a low frequency to a high frequency. For example, the frequency range may be one or more frequencies between 20 Hz and 20,000 Hz which is the typical audio frequency range for music. The source audio content may comprise digital samples of audio. A frequency and magnitude may be associated with one or more digital samples.

A spectral coverage of the source audio content may determine whether the continuous calibration is suspended. Digital samples of the source audio content may in a time domain. The digital samples of the source audio content may be transformed from the time domain into a frequency domain representation by a transform function such as a Fast Fourier Transform (FFT). The frequency domain representation of the source audio content may represent the spectral coverage of the source audio content.

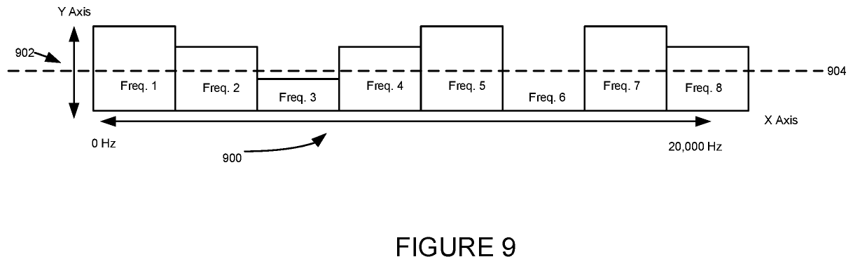

The spectral coverage of the source audio content may be subdivided into frequency bins. FIG. 9 illustrates an example of frequency binning. In FIG. 9, the frequency domain representation of the source audio content may be subdivided in frequency bins, shown as exemplary frequency bins Freq. 1 to Freq. 8. The frequency bins may be arranged along an X axis 900 and represent a subset of uniform or non-uniform frequency ranges between a low frequency, e.g., 20 Hz, and a high frequency, e.g., 20,000 Hz. A magnitude of each of the frequency bins may then represent an amount of spectral content within the frequency bin as shown by the Y axis 902. The magnitude may be an average of the magnitudes in the frequency bin, a maximum magnitude in the frequency bin, or some other measure.

If a magnitude of the spectral content in one or more frequency bins is less than a threshold level, then continuous calibration (and perhaps also discrete calibration) may not be performed. Referring to FIG. 9, the magnitude of the frequency content in Freq. 3 and Freq. 6 bins may be less than the threshold 902. As a result, the continuous calibration may not be performed.

In another example, a continuous calibration may be performed even though a magnitude of the spectral content in one or more frequency bins is less than a threshold level. For example, the frequency bins with insufficient spectral coverage may be “logged” and filled in with spectral content when the source audio content has sufficient spectral content in those frequency bins. In the meantime, other sufficient spectral content (e.g., covering a same frequency range of the frequency bin) may be used during the calibration. The other sufficient spectral content may be based on source audio content previously played back by the audio playback device or predetermined spectral content. As another example, the spectral content in those frequency bins with insufficient spectral content may be estimated through a filtering process such as interpolation. Spectral content in adjacent frequency bins may be interpolated to fill in the frequency bins with insufficient spectral content. Other arrangements are also possible.

At 804, a first stream of audio may be received, e.g., via a wide area network. The first stream may comprise source audio content to be played back by the audio playback device. Further, the stream may be segmented into one or more chunks of data. For example, the chunks may take the form of packets of digital samples of audio content. These chunks of data may be stored on the audio playback device being calibrated and/or stored on a computing device associated with the calibration of the audio playback device.

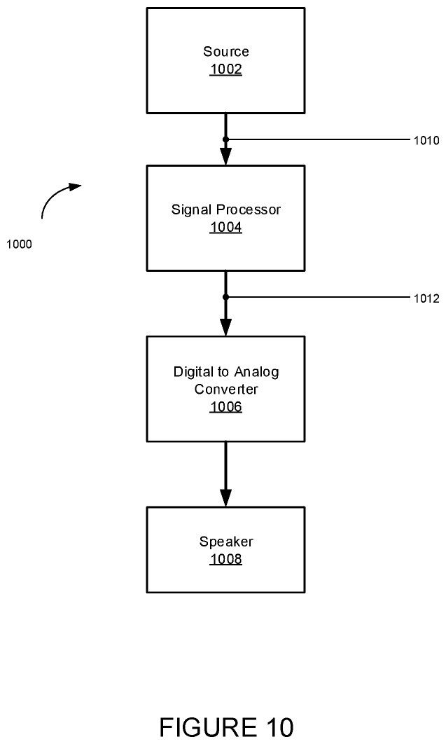

This source content may be received via an audio pipeline. FIG. 10 shows such an exemplary audio pipeline 1000. The audio pipeline 1000 may include a source 1002, a signal processor 1004, a digital to analog converter 1006, and a speaker 1008 coupled via one or more communication links.

The audio pipeline 1000 may reside on an audio playback device, the controller device, computing device, NMD, or a combination thereof. In the case of the audio pipeline residing on an audio playback device, the communication links may take the form of traces on a printed circuit board. In the case of the audio pipeline residing on the combination thereof, the communication links may take the form of a wired or wireless network such as an Ethernet or WiFi network.

The source 1002 may be a storage device such as memory or a hard drive which stores source audio content. Alternatively, the source 1002 may be a computing device such as a music service provider which stores and provides the source audio content to the audio playback device. The source audio content may take the form of an audio file of digital samples defining audio content in a time domain.

The signal processor 1004 may apply one or more filtering algorithms to the source audio content prior to the audio playback device outputting an audio signal. The filtering algorithms may vary based one or more of a volume setting of the audio playback device, previous calibration of the playback device, device orientation, content type, etc. Further, the signal processor 1004 include one or more of a sample rate converter, bit depth converter, and channel up/down mixer. The sample rate converter may change a sample rate of the source audio content. The sample rate may define a number of samples representing the source audio content per unit time. The bit depth converter may change a bit depth of the source audio content signal. The bit depth may be a number of bits used to represent a digital sample. The channel up/down mixer may mix source audio content from different channels such as a left and right channel of stereo sound. The signal processor 1004 may perform other functions as well.

In embodiments, the signal processor 1004 may process the source audio content in a digital domain and output a processed digital signal. The digital to analog converter 1006 may convert the digital signal of the signal processor 1004 to an analog signal. The analog signal may be output to the speaker 1008 which converts the analog signal to audible audio.

The source audio content that is used in calibration may be received at the tap 1010 or tap 1012 of FIG. 10. In the case that the source audio content is received at 1010, then processing that would otherwise be applied by the signal processor 1004 may need to be applied to the source audio content prior to calculating the estimated frequency response at 808 which is discussed below.

At 806, a second stream of audio may be received. The second stream may be a recorded audio signal output by the audio playback device based on the audio playback device playing the source audio content. The audio signal may be a time domain representation of the audio content output by the playback device. The stream may be segmented into one or more chunks of data, e.g., packets. The received audio signal may be stored on the audio playback device or passed to another network device, such as a computing device, another audio playback device, control device or NMD.

The audio playback device that is being calibrated may record the audio signal. The audio signal may be recorded via one or more microphones co-located on the audio playback device being calibrated. Alternatively, the audio signal may be recorded via one or more microphones in a spatially different location from the audio playback device being calibrated. For example, another audio playback device may record this audio signal, a network device may receive this audio signal, and/or a NMD may record this audio signal.

At 808, the received first stream of audio, e.g., source audio content, and the received second stream of audio, e.g., recorded audio signal, may be processed to calculate an estimated frequency response of the audio playback device. The processing may be performed by one or more of a computing device, audio playback device being calibrated, another audio playback device, NMD, and/or controller device. The processing may be performed in real time as chunks of source audio content is received and audio signal output by the audio playback device is recorded. This real-time processing may be performed when there is sufficient processing power available. Alternatively, when limited processing power is available, processing may be performed after a “sufficient” amount of chunks of source audio content and audio signal is recorded. Sufficient may be dependent on implementation but may be when a certain number of chunks or packets associated with the source audio content and/or the recorded audio signal output by the audio playback device is received. For example, sufficient may be the source audio content received/audio output signal recorded in a one second interval, a one-minute interval, or some time interval in between. Alternatively, sufficient may be a certain number of packets. Other arrangements are also possible.

Chunks of the source audio content and the audio signal output by the audio playback device may be in a time domain. The chunks in the time domain may be transformed into a frequency domain representation using a transformation technique such as the Fast Fourier Transform (FFT). The frequency domain representation identifies spectral content of the chunks. In some embodiments, spectral content may be added to the spectral content of the chunks of the source audio content and/or the audio signal output by the audio playback device. Consistent with the discussion above with respect to FIG. 9, the spectral content added may be based on spectral content already in one or more frequency bins associated the frequency domain representation. The spectral content added may be source audio content previously played back by the audio playback device, the audio signal output by the audio playback previously, and/or predetermined spectral content. Additionally, or alternatively, the spectral content added may be based on a filtering process such as interpolation being performed on the spectral content already in one or more bins. Other arrangements are also possible.

The source audio content and the audio signal output may be each represented as a vector of data with a magnitude and phase in the frequency domain. A transfer function may be a difference between the source audio content vector(S) and the output audio signal vector (M).

This transfer function may be calculated based on an adaptive echo cancellation algorithm. The characteristic equation for adaptive echo cancellation may be represented as:

$$M = [ S * H + X ] \qquad ( 1 )$$

where M is a complex vector in the frequency domain representing a magnitude and phase of the recorded audio signal output by the audio playback device;
S is a complex vector in the frequency domain representing a magnitude and phase of the source audio content vector;
H is a complex transfer function in the frequency domain representing a difference between the S and M in the absence of any recorded interference in M; and
X represents the recorded interference, e.g., static noise (e.g., buzz) or background noise (e.g., speech) in M. If there is no recorded interference in M, then M=S*X and X=0.

A real part of H, e.g., a magnitude component of the S to M transfer function may be calculated as:

$$mag {H}_{n} = ( mag {S}_{n} - mag {M}_{n} ) {a}_{n} + ( 1 - {a}_{n} ) ( mag {H}_{n - 1} ) \qquad ( 2 )$$

where a is a signal to interference ratio, e.g., the signal may be S and the interference may be the recorded interference X. a may be represented as a function of a logarithmic value normalized between 0 and 1;
magSₙ is a magnitude component vector of the source audio content vector;
magMₙ is a magnitude component vector of the recorded output audio signal vector; and
n is an iteration.

With each iteration, a magnitude component vector of the output audio signal vector magM, a magnitude component vector of the source audio content magS, and the magnitude component of the S to M transfer function magH from one iteration is used to calculate the magnitude component of the S to M transfer function for the next iteration.

The following calculation may be performed for each iteration:

$$mag {M}_{n} - mag {S}_{n} * mag {H}_{n} \qquad ( 3 )$$

where magMₙ is a magnitude component vector of the recorded output audio signal vector;
magSₙ is a magnitude component vector of the source audio content vector;
magHₙ is a magnitude component of the S to M transfer function.

The transfer function may converge when a result of equation (3) is substantially zero. Alternatively, for each iteration n an average may be calculated based on a result of equation (3) for the current iteration and results of equation (3) for one or more past iterations. The transfer function may converge when a slope of averages based on equation (3) over a plurality of iterations is substantially zero. Various well known convergence algorithms such as L2 norm may also indicate convergence.

An estimated frequency response of the audio playback device may be determined based on magH and a self-response of the audio playback device in an anechoic chamber. The self-response of the audio playback device in an anechoic chamber may involve playing audio by the audio playback device in an anechoic chamber and recording the audio signal output by the audio playback device at the audio playback device. This self-response may be determined during a testing phase of the audio playback device (either of the audio playback device itself or another audio playback device which is similar to the audio playback device) and stored in the computing device, controller device, NMD, or the audio playback device itself In some instances, the estimated frequency response may be a difference between magH and the self-response of the audio playback device in the anechoic chamber.

In one example, the network device which records the audio signal output by the audio playback device may be a controller device, NMD, or another playback device at a spatial location different from where the audio playback device is located. In this regard, the estimated frequency response may be a test response, e.g., a response of the audio playback device at the spatial location of the network device. In another example, the audio playback device may play back the source audio content and record the audio signal output by the playback device via one or more microphones proximate to the audio playback device. For example, the microphone may be co-located physically on or in the playback device or wired or wirelessly connected to the audio playback device. The estimated frequency response may be a self-response, i.e., a response of the audio playback device determined based on receiving the audio signal output by the audio playback device at the one or more microphones of the audio playback device.

Further, the estimated frequency response may be an absolute response of the audio playback device or a filtered response of the audio playback device. The absolute response may be the estimated frequency response of the audio playback device based on the source audio content and recorded audio signal output received over a given period of time. The filtered response may be an average of estimated frequency responses calculated at different periods of time. In some examples, the estimated frequency response may also be weighted with higher weightings applied to estimated frequency responses which may have been determined more recently and lower weightings applied to estimated frequency responses which may have been determined less recently. The filtered response may continue to be updated as estimated responses are determined for different periods of time (i.e., a moving average). Additionally, if the network device is spatially moving, the filtered response may also be a space averaged response across the portion of space covered by the network device during the period of time.

In the case of discrete calibration, processing associated with frequency response estimation may stop once the estimated frequency response is determined. In the case of a continuous calibration, processing may continue with calculation of updated frequency response estimation as source audio content is received and audio signal output by the audio playback device is recorded.

In either case, at 810, the estimated frequency response may be used to adjust (e.g., calibrate) acoustics of the audio playback device. The adjustment may be performed by one or more of the audio playback device being calibrated, another audio playback device, an NMD, a controller device, and/or a computing device such as a server.

The calibration may be performed in a plurality of ways. In one example, an audio processing algorithm may be selected from a database of audio processing algorithms based on the estimated frequency response of the audio playback device. In another example, the audio processing algorithm may be dynamically computed based on the estimated frequency response of the audio playback device. The audio processing algorithm may take the form of a filter or equalization setting which is used to adjust acoustics of the audio playback device for the environment. This filter or equalization may be applied to the audio content played by the playback device until such time that the filter or equalization is changed or is no longer valid.

The filter or equalization setting may be applied by the audio playback device. Alternatively, the filter or equalization may be applied by another audio playback device, the server, and/or the controller device which then provides the processed audio content to the audio playback device for playback via a communication network. Other arrangements are also possible.

In some situations, the audio playback device cannot be calibrated because the transfer function H does not converge. The audio playback device may have a plurality of microphones. Each of the microphones may record source audio content. In this regard, a transfer function H may be calculated for each microphone of a plurality of microphones in a playback device. Failure to converge may be indicated by a lack of correlation between a transfer function H associated with one microphone of the audio playback device and transfer functions H associated with one or more of the other microphones of the audio playback device. In this situation, the lack of correlation may indicate that the playback device should be moved. Then, the calibration process can be started again.

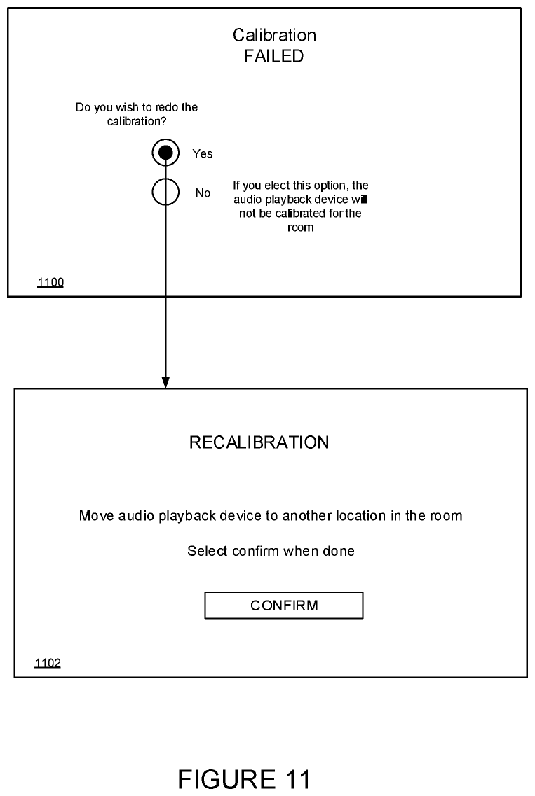

FIG. 11 illustrates an exemplary user interface 1100 in the event that the audio playback device is unable to be calibrated. A user may be requested to select whether to perform the calibration again. If the user selects to calibrate again, a user interface 1102 may be presented that requests the user to take some action. The action illustrated in FIG. 11 is for the user to move the audio playback device and confirm the audio playback device has moved to complete the calibration.

Alternatives to moving the playback device when the calibration is not successful. may include, but is not limited to those described in U.S. patent application Ser. No. 14/864,393, entitled “Facilitating Calibration of an Audio Playback Device” and/or U.S. patent application Ser. No. 15/096,827, entitled “Calibration of Audio Playback Devices”, the contents each of which is herein incorporated by reference in its entirety. Further, in other embodiments, the user interface may provide an indication that calibration cannot be performed.

In other situations, the audio playback device cannot be calibrated at all. The audio playback device may be impaired, e.g., a microphone or speaker of the audio playback device may be broken. Impairments in the audio playback device may be detected based on analyzing the transfer function H determined for the audio playback device. The transfer function H may define a response for a range of frequencies. If the transfer function H for the audio playback device (and/or a microphone of the audio playback device) does not have a frequency response for a subset of the range of frequencies (e.g., the response is substantially zero) while the transfer function H of other audio playback devices (and/or a microphone of the audio playback device) in the environment do have a frequency response for the subset of the range of frequencies (e.g., the response is substantially non-zero), then the audio playback device may be impaired such that calibration cannot be performed. To facilitate determining whether the audio playback device is impaired, the network device performing the calibration may receive from an audio playback device, computing device, or NMD the transfer function H of one or more audio playback also in the environment.

Methods and the other processes disclosed herein may include one or more operations, functions, or actions. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the methods and other processes disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, each block in the figures may represent circuitry that is wired to perform the specific logical functions in the process.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A playback device comprising:
at least one audio transducer;
at least one microphone;
a network interface;
at least one processor;
a housing carrying the at least one audio transducer, the at least one microphone, the network interface, and the at least one processor; and
at least one non-transitory computer-readable medium comprising program instructions that are executable by the at least one processor such that the playback device is configured to:
receive, via the network interface, a first audio signal representing first audio content;
play back the first audio content via the at least one audio transducer;
during playback of the first audio content, capture a second audio signal via the at least one microphone;
apply an adaptive acoustic echo canceller to the second audio signal using the first audio signal as a reference;
estimate environment acoustic characteristics based on output of the adaptive acoustic echo canceller;
determine a calibration that at least partially offsets the estimated environment acoustic characteristics; and
apply the determined calibration during playback of second audio content.

2. The playback device of claim 1, further comprising an audio pipeline comprising a digital to analog converter, a signal processor, and an audio amplifier, and wherein the program instructions that are executable by the at least one processor such that the playback device is configured to play back the first audio content comprise program instructions that are executable by the at least one processor such that the playback device is configured to:
apply signal processing to the first audio signal;
convert the signal-processed first audio signal to an analog signal;
amplify the analog signal; and
play back the amplified analog signal via the at least one audio transducer.

3. The playback device of claim 2, wherein the program instructions that are executable by the at least one processor such that the playback device is configured to apply adaptive acoustic echo canceller to the second audio signal using the first audio signal as the reference comprise program instructions that are executable by the at least one processor such that the playback device is configured to:
obtain the first audio signal as the reference from a tap in the audio pipeline after the signal processing is applied.

4. The playback device of claim 2, wherein the program instructions that are executable by the at least one processor such that the playback device is configured to apply adaptive acoustic echo canceller to the second audio signal using the first audio signal as the reference comprise program instructions that are executable by the at least one processor such that the playback device is configured to:
obtain the first audio signal as the reference from a tap in the audio pipeline before the signal processing is applied; and
apply the signal processing to the reference.

5. The playback device of claim 1, wherein the output of the adaptive acoustic echo canceller comprises a transfer function representing a difference between the first audio signal and the second audio signal after the adaptive acoustic echo canceller has converged.

6. The playback device of claim 5, wherein the program instructions that are executable by the at least one processor such that the playback device is configured to estimate the environment acoustic characteristics based on the output of the adaptive acoustic echo canceller comprise program instructions that are executable by the at least one processor such that the playback device is configured to:
estimate the environment acoustic characteristics as a difference between a first response represented by the transfer function and a second response representing output of the playback device in an anechoic chamber.

7. The playback device of claim 1, wherein the program instructions that are executable by the at least one processor such that the playback device is configured to determine the calibration that at least partially offsets the estimated environment acoustic characteristics comprise program instructions that are executable by the at least one processor such that the playback device is configured to:
select a particular calibration from among a plurality of pre-determined calibrations, the particular calibration corresponding to the estimated environment acoustic characteristics.

8. The playback device of claim 1, wherein the program instructions that are executable by the at least one processor such that the playback device is configured to determine the calibration that at least partially offsets the estimated environment acoustic characteristics comprise program instructions that are executable by the at least one processor such that the playback device is configured to:
compute an audio processing algorithm that at least partially offsets the estimated environment acoustic characteristics when applied to playback by the playback device.

9. The playback device of claim 8, wherein the program instructions that are executable by the at least one processor such that the playback device is configured to compute the audio processing algorithm comprise program instructions that are executable by the at least one processor such that the playback device is configured to:
determine filter coefficients of a filter represented by the audio processing algorithm, the filter adjusting frequency components of audio signals output by the playback device to offset the acoustic characteristics.

10. The playback device of claim 1, further comprising a network microphone device, and wherein the at least one non-transitory computer-readable medium further comprises program instructions that are executable by the at least one processor such that the network microphone device is configured to:
capture voice inputs via the at least one microphone.

11. A system comprising:
a playback device, the playback device comprising:
at least one audio transducer;
at least one microphone;
a network interface;
a housing carrying the at least one audio transducer, the at least one microphone, and the network interface; and
at least one processor;
at least one non-transitory computer-readable medium comprising program instructions that are executable by the at least one processor such that the system is configured to:
receive, via the network interface, a first audio signal representing first audio content;
play back the first audio content via the at least one audio transducer;
during playback of the first audio content, capture a second audio signal via the at least one microphone;
apply an adaptive acoustic echo canceller to the second audio signal using the first audio signal as a reference;
estimate environment acoustic characteristics based on output of the adaptive acoustic echo canceller;
determine a calibration that at least partially offsets the estimated environment acoustic characteristics; and
apply the determined calibration during playback of second audio content.

12. The system of claim 11, further comprising an audio pipeline comprising a digital to analog converter, a signal processor, and an audio amplifier, and wherein the program instructions that are executable by the at least one processor such that the system is configured to play back the first audio content comprise program instructions that are executable by the at least one processor such that the system is configured to:
apply signal processing to the first audio signal;
convert the signal-processed first audio signal to an analog signal;
amplify the analog signal; and
play back the amplified analog signal via the at least one audio transducer.

13. The system of claim 12, wherein the program instructions that are executable by the at least one processor such that the system is configured to apply adaptive acoustic echo canceller to the second audio signal using the first audio signal as the reference comprise program instructions that are executable by the at least one processor such that the system is configured to:
obtain the first audio signal as the reference from a tap in the audio pipeline before the signal processing is applied; and
apply the signal processing to the reference.

14. The system of claim 11, wherein the output of the adaptive acoustic echo canceller comprises a transfer function representing a difference between the first audio signal and the second audio signal after the adaptive acoustic echo canceller has converged.

15. The system of claim 14, wherein the program instructions that are executable by the at least one processor such that the system is configured to estimate the environment acoustic characteristics based on the output of the adaptive acoustic echo canceller comprise program instructions that are executable by the at least one processor such that the system is configured to:
estimate the environment acoustic characteristics as a difference between a first response represented by the transfer function and a second response representing output of the playback device in an anechoic chamber.

16. The system of claim 11, wherein the program instructions that are executable by the at least one processor such that the system is configured to determine the calibration that at least partially offsets the estimated environment acoustic characteristics comprise program instructions that are executable by the at least one processor such that the system is configured to:
select a particular calibration from among a plurality of pre-determined calibrations, the particular calibration corresponding to the estimated environment acoustic characteristics.

17. The system of claim 11, wherein the program instructions that are executable by the at least one processor such that the system is configured to determine the calibration that at least partially offsets the estimated environment acoustic characteristics comprise program instructions that are executable by the at least one processor such that the system is configured to:
compute an audio processing algorithm that at least partially offsets the estimated environment acoustic characteristics when applied to playback by the playback device.

18. The system of claim 17, wherein the program instructions that are executable by the at least one processor such that the system is configured to compute the audio processing algorithm comprise program instructions that are executable by the at least one processor such that the system is configured to:
determine filter coefficients of a filter represented by the audio processing algorithm, the filter adjusting frequency components of audio signals output by the playback device to offset the acoustic characteristics.

19. The system of claim 11, further comprising a network microphone device, and wherein the at least one non-transitory computer-readable medium further comprises program instructions that are executable by the at least one processor such that the network microphone device is configured to:
capture voice inputs via the at least one microphone.

20. A method to be performed by a playback device, the method comprising:
receiving, via a network interface, a first audio signal representing first audio content, wherein the playback device comprises a housing carrying at least one audio transducer, at least one microphone, and the network interface;
playing back the first audio content via the at least one audio transducer;
while playing back the first audio content, capturing a second audio signal via the at least one microphone;
applying an adaptive acoustic echo canceller to the second audio signal using the first audio signal as a reference;
estimating environment acoustic characteristics based on output of the adaptive acoustic echo canceller,
determining a calibration that at least partially offsets the estimated environment acoustic characteristics; and
applying the determined calibration during playback of second audio content.
